(19) United States
(12) Patent Application Publication
(10) Pub. No.: US 2005/0253513 A1
(43) Pub. Date: Nov. 17, 2005

(54) Planar light source device, method for manufacturing the same, and display device having the same

(76) Inventors: Hae-II Park, Seoul (KR); In-Sun Hwang, Suwon-si (KR); Sang-Yu Lee, Yongin-si (KR); Jin-Seob Byun, Seoul (KR)

Correspondence Address: CANTOR COLBURN, LLP, 55 GRIFFIN ROAD SOUTH, BLOOMFIELD, CT, 06002, US

(21) Appl. No.: 11/124,010

(22) Filed: May 6, 2005

(30) Foreign Application Priority Data
May 17, 2004 (KR) 2004-34676

(51) Int. Cl. H01J 61/00; H01J 61/30; H01J 17/00

(52) U.S. Cl. 313/581; 313/634

(57) ABSTRACT

A display device comprises a planar light source device comprising a light source body having multiple opening portions for air exhaust and injection of the discharging gases, at least one affixing member being affixed to the light source body and sealing each of the multiple opening portions, at least one getter being on the at least one affixing member and corresponding to each of the multiple opening portions, and first and second electrodes being formed on opposing edges defining the outer surface of the light source body, a display unit displaying images using light from the planar light source device, and an inverter applying discharging voltages to the first and second electrodes for driving the planar light source device. According to this configuration, the present invention may reduce the thickness of the planar light source device and improve getting efficiency of the impurities and emitting efficiency of mercury by increasing the surface area of the getter.

### BACKGROUND OF THE INVENTION

1. Field of the Invention

The present invention relates to a planar light source device, a method for manufacturing the same, and a display device having the same, and more particularly, to a planar light source device having no exhaust tube for exhausting air from inside of the planar light source and for injecting gases to be discharged, a method for manufacturing the same, and a display device having the same.

2. Description of the Related Art

Generally, a cold cathode fluorescent lamp (CCFL) is used as a backlight assembly for a display device. Two types of the cold cathode fluorescent lamps include edge light and direct light types depending on the location of a light source, for example. The two types of the cold cathode fluorescent lamps have some problems in that light efficiency is reduced by multiple optical members, such as a light guide plate or a diffusing plate, etc., and uniformity of luminance is reduced by complicated structures. Recently, a planar light source device has been developed to eliminate these problems. Generally, the planar light source device includes a light source body and electrodes. The inside of the light source body has multiple discharging regions, and the electrodes are formed on both edges of the light source body and apply discharging voltages to the light source body. Further, the planar light source device includes getters and an exhaust tube. The getters supply mercury gas for plasma discharge and get impurities inside of the light source body. The exhaust tube is formed at one surface of the light source body, and exhausts air inside of the light source body and injects gases to be discharged inside of the light source body through the exhaust tube. In the conventional planar light source device, the getters are disposed in the exhaust tube and the exhaust tube is sealed after the exhausting and injecting processes. Next, the getters in the exhaust tube supply mercury gas at a high frequency to the inside of the light source body, and finally the exhaust tube is eliminated. However, this results in some problems in that the overall thickness of the planar light source device is increased as a result of remaining marks of the exhaust tube and yield of the product is reduced by frequent damages in manufacturing processes.

### SUMMARY OF THE INVENTION

The present invention provides a planar light source device having a planar a light source body comprising multiple discharging regions and at least one opening portion for air exhaust and injection of gases to be discharged; at least one affixing member being affixed to the light source body and seals the at least one opening portion; at least one getter being on the at least one affixing member and corresponds to the at least one opening portion; and first and second electrodes being formed on opposing edges defining the outer surface of the light source body.

Further, the present invention provides a display device having a planar light source device comprising a light source body having multiple discharging regions and multiple opening portions for air exhaust and injection of the discharging gases; at least one affixing member being affixed to the light source body and seals each of the multiple opening portions; at least one getter being on the at least one affixing member and corresponds to each of the multiple opening portions; and first and second electrodes being formed on opposing edges defining the outer surface of the light source body and intersect the multiple discharging regions; a display unit displaying images using light from the planar light source device; and an inverter applying discharging voltages to the first and second electrodes for driving the planar light source device.

Further, the present invention provides a method of manufacturing a planar light source device comprising exhausting air in the inside of a light source body through at least one opening portion; injecting gases to be discharged inside of the light source body through the at least one opening portion; sealing the at least one opening portion using at least one affixing member, the at least one affixing member has a flat shape and is on at least one getter; and applying a high frequency to the at least one getter for supplying mercury to the inside of the light source body.

These and other objects, features, and advantages of the present invention will become apparent from the following detailed description of embodiments thereof, which is to be read in connection with the accompanying drawings.

This application relies for priority upon Korean Patent Application No. 2004-0034676 filed on May 17, 2004, the contents of which are herein incorporated by reference in its entirety.

### BRIEF DESCRIPTION OF THE DRAWINGS

The above and other features and advantages of the present invention will become more apparent by describing in detail embodiments thereof with reference to the accompanying drawings, in which:

FIG. 1 is a perspective view of a planar light source device according to an exemplary embodiment;

FIG. 2 is a cross-sectional view of the planar light source device of FIG. 1;

FIG. 3 is a perspective view of a affixing member and a getter of FIG. 1;

FIG. 4 is a cross-sectional view taken along line 4-4 of FIG. 3;

FIG. 5 is a perspective view of the getter of FIG. 3 according to another exemplary embodiment;

FIG. 6 is a perspective view of the light source body of FIG. 1 according to another exemplary embodiment;

FIG. 7 is a cross-sectional view of the light source body of FIG. 6;

FIG. 8 is a flowchart of a method of manufacturing the planar light source device according to one exemplary embodiment; and

FIG. 9 is a perspective view of a liquid crystal display device according to one exemplary embodiment.

### DETAILED DESCRIPTION OF THE INVENTION

Hereinafter the embodiments of the present invention will be described in detail with reference to the accompanying drawings.

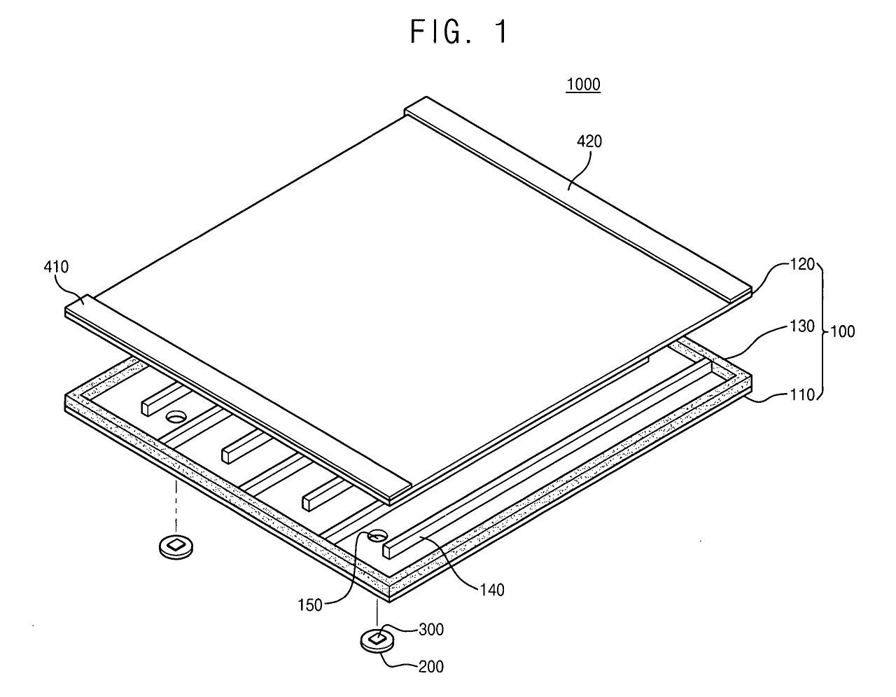

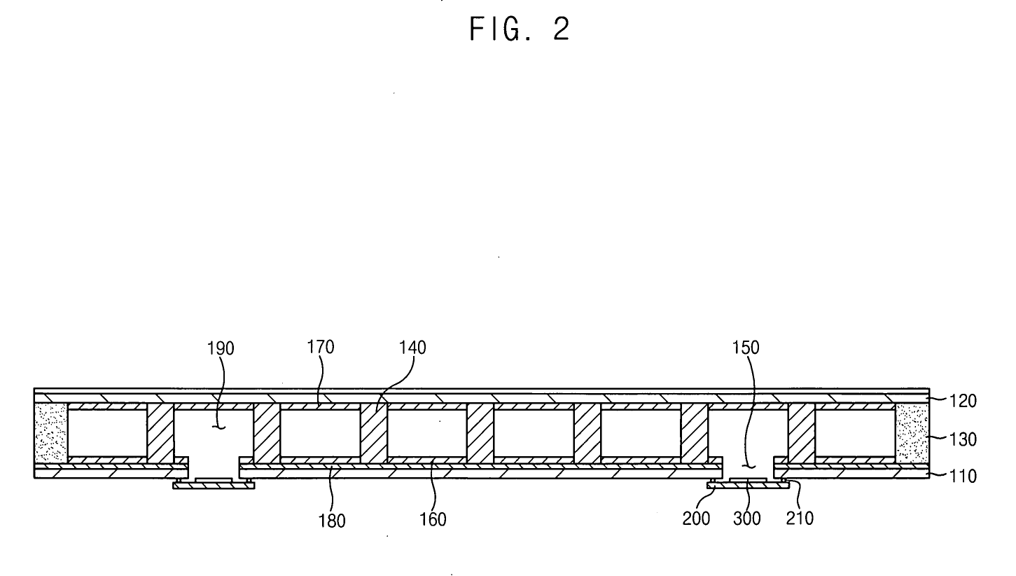

FIG. 1 is a perspective view of a planar light source device according to an exemplary embodiment, and FIG. 2 is a cross-sectional view of the planar light source device of FIG. 1.

Referring to FIGS. 1 and 2, the planar light source device 1000 comprises a light source body 100, multiple affixing members 200 (just two shown), and multiple getters 300 (just two shown). The light source body 100 has multiple discharging regions 190 and multiple opening portions 150 (just two shown) for exhausting air inside of the light source body 100 and injecting gases to be discharged. In other words, the light source body 100 comprises a first substrate 110, a second substrate 120 facing the first substrate 110, and a sealing member 130 therebetween coupling the first substrate 110 with the second substrate 120. The first and second substrates 110 and 120 each have a flat shape and are each formed of a transparent glass substrate which transmits visible light and blocks ultraviolet light, for example. The sealing member 130 is disposed between the first and second substrates 110 and 120 and seals along a perimeter defining the first and second substrates 110 and 120, and thus forms an empty space.

The light source body 100 further comprises multiple partitioning members 140 formed inside of the light source body 100. The multiple partitioning members 140 are formed parallel with each other having a uniform gap between contiguous partitioning members 140. Each of the partitioning members 140 is bar shaped with top and bottom surfaces of the partitioning members 140 affixed to the first and second substrates 110 and 120, respectively. Further, each of the partitioning members 140 is formed so that at least one of edge of each of the partitioning members is apart from a sidewall of the light source body 100, for example, an inner surface of the sealing member 130 by a certain distance. This configuration provides a connection path so that the discharging gases injected inside of the light source body 100 are uniformly distributed in the multiple discharging regions 190.

Multiple opening portions 150 are formed on the first substrate 110. The light source body 100 exhausts air inside of the light source body 100 through the multiple opening portions 150, and receives the discharging gases for plasma discharging. The discharging gases inside of the light source body 100 comprise Krypton, Xenon, Ar, and Ne, etc., for example. Meanwhile, the multiple opening portions 150 may be formed at locations where the partitioning member 140 does not overlap the first substrate 110. In this embodiment, the multiple opening portions 150 are formed on the first substrate 110, but may be formed on the second substrate 120.

Each of the multiple opening portions 150 are sealed by each of the multiple affixing members 200 after the air exhaust and injection of the discharging gases. Each of the affixing members 200 has a thin flat shape and reduces the thickness of the planar light source device 1000. Further, each of the affixing members 200 has a wider area than the multiple opening portions 150 and covers the whole area of each of the multiple opening portions 150. The multiple affixing members 200 comprise the same glass material as the first and second substrates 110 and 120. Each of the multiple affixing members 200 is affixed to the light source body 100 corresponding to each of the multiple opening portions 150 by an adhesive member 210. The adhesive member 210 may comprise frit having a melting point less than the light source body 100. The frit is a compound of SiO₂, PbO, B₂O₅, etc., for example.

Meanwhile, each of the getters 300 is secured to one surface of the affixing member 200 before each of the affixing members 200 is coupled with the light source body 100. Each of the getters 300 is on the one surface of the affixing member 200. The getters 300 may comprise a flat getter or multiple line getters. Each of the getters 300 is also located corresponding to each of the opening portions 150 when each of the affixing members 200 is coupled with the light source body 100. The getters 300 supply mercury (Hg) to the inside of the light source body 100, and gets the impurities inside of the light source body 100.

In this embodiment, the light source body 100 further comprises first and second fluorescent layers 160 and 170, and a reflecting layer 180. The first florescent layer 160 faces the second florescent layer 170 and the reflecting layer 180 is disposed between the first substrate 110 and the first fluorescent layer 160. The first and second fluorescent layers 160 and 170 are formed on the first and second substrates 110 and 120, respectively, except for where the partitioning members 140 are formed. However, the first and second fluorescent layers 160 and 170 may be formed at the side surface of the partitioning members 140. The first and second fluorescent layers 160 and 170 are excited by ultraviolet light that occurs by plasma discharging in the discharging regions 190 and emit visible light. The reflecting layer 180 reflects the visible light to the second substrate 120 and prevents the visible light from leaking into the first substrate 110.

Further, the light source body 100 may further comprise a protecting layer (not shown) disposed between the second substrate 120 and the second fluorescent layer 170 or between the first substrate 110 and the reflecting layer 180. The protecting layer prevents chemical reaction of mercury with at least one of the first and second substrates 110 and 120, and thus prevents loss of mercury.

The planar light source device 1000 further comprises first and second electrodes 410 and 420 formed at a pair of outboards ends of the light source body 100. The first and second electrodes 410 and 420 are formed on opposing edges of the second substrate 120 and formed in a direction perpendicular to a direction of the partitioning members 140. The first and second electrodes 410 and 420 are formed by a spray coating method, etc using a suitable conductive material, such as a metal power being made of Cu, Ni, Ag, Au, Al, Cr, etc., for example. Further, the first and second electrodes 410 and 420 may be formed by an aluminum tape, a silver paste coating, or a method of dipping both edges of the light source body 100 into a melted conductive material. The first and second electrodes 410 and 420 apply discharging voltages to the light source body 100 and cause plasma discharging inside of the light source body 100.

In this embodiment, the first and second electrodes 410 and 420 are formed at the outer ends of the second substrate 120, but may be formed on the outer ends of the first substrate 110 or the outer ends of the first and second substrates 110 and 120.

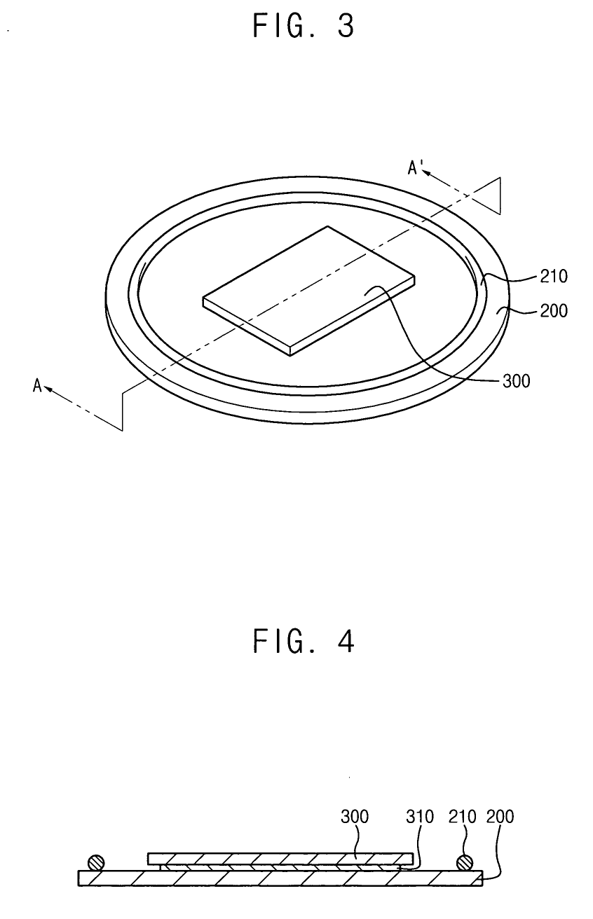

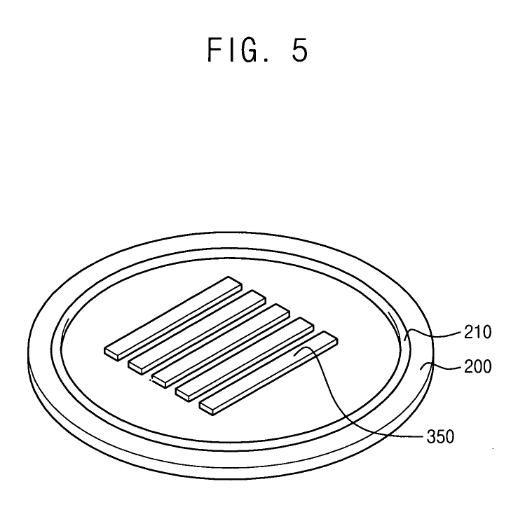

FIG. 3 is a perspective view of the affixing members 200 and the getter 300 of FIG. 1, and FIG. 4 is a cross-sectional view taken along lines 4-4 of FIG. 3.

Referring to FIGS. 3 and 4, the affixing members 200 have a thin flat shape and a wider area than an area of the opening portions 150. The affixing members 200 are formed of the same glass material as the first substrate 110 or frit including a compound of the glass material. In this embodiment, the affixing members 200 have a circular shape, but may have various other shapes, such as rectangular, etc. The affixing members 200 are affixed to the light source body 100 by the adhesive member 210.

The adhesive member 210 is formed at one surface of each of the affixing members 200 to surround the edge of each of the affixing members 200. The adhesive member 210 may be formed surrounding the opening portions 150 not to overlap the opening portion 150 when the adhesive member 210 adheres the affixing members 200 to the light source body 100. The adhesive member 210 has a melting point less than a melting point of the light source body 100 and the affixing member 200 so that the adhesive member 210 couples the affixing members 200 with the light source body 100. The adhesive member 210 may comprise a compound of the glass material melted at about 350° C., for example. Accordingly, the adhesive member 210 is adhered to the affixing members 200 or the light source body 100, and then the affixing members 200 are coupled with the light source body 100 by heating at more than about 350° C.

Meanwhile, each of the getters 300 is secured to one surface of each of the affixing members 200 through each of the securing members 310 before each of the affixing members 200 is affixed to the light source body 100. Each of the getters 300 is on the one surface of each of the affixing members 200. The securing members 310 comprise frit or both-sided tape, etc., for example. The securing members 310 prevent the getters 300 from entering the inside of the light source body 100.

The getters 300 comprise an amalgam material being an alloy of mercury and other metal and a getter alloy for getting impurities. The amalgam material may comprise an alloy of mercury and natrium (Hg—Na), for example, and emits mercury gas into the inside of the light source body 100 by high frequency. The getter alloy gets the impurities inside of the light source body 100 and removes the impurities. In other words, although air inside of the light source body 100 is exhausted before the light source body 100 is sealed by the affixing members 200, the impurities, for example, CO, N₂, CO₂, O₂, or H₂O, etc. exist inside of the light source body 100. As a result, the impurities reduce the lifespan and quality of the planar light source device 1000. However, the getter alloy may extend the lifespan of the planar light source device 1000 by continuously getting the impurities inside of the light source body 100. The getter alloy may comprise an alloy of zirconium and aluminum (Zr—Al), for example. In this embodiment, the getters 300 have a flat shape and may improve emitting efficiency of mercury gas and getting efficiency of the impurities over its wide surface area.

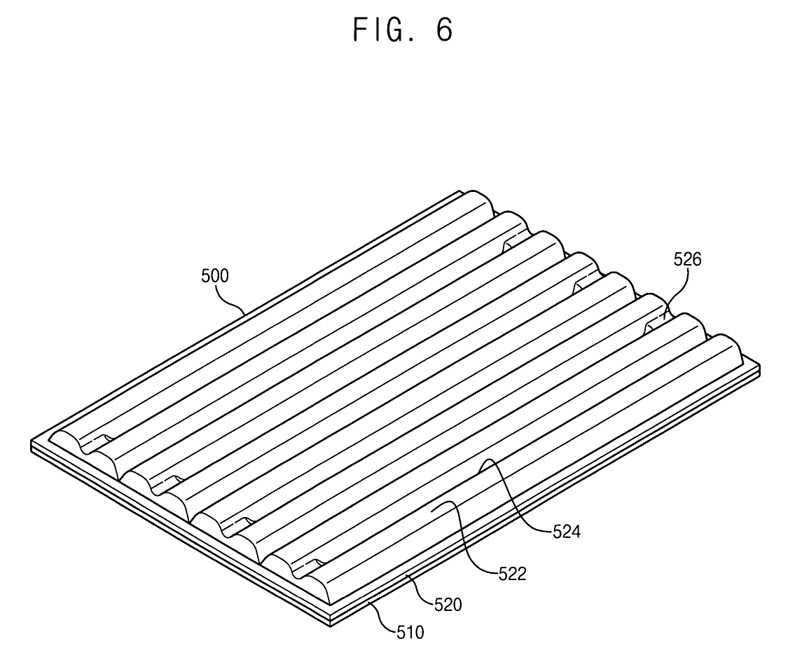

FIG. 5 is a perspective view of the getters 350 of FIG. 3 according to another exemplary embodiment.

Referring to FIG. 5, the multiple getters 350 are each bar shaped and each of the getters 350 is formed parallel with each other. The getters 350 comprise an amalgam material and a getter alloy. Each of the getters 350 is secured to one surface of each of the affixing members 200 by a securing member (not shown). Each of the getters 350 is on the one surface of each of the affixing members 200. As the getters 350 are more densely formed, the getters 350 increase in surface area. Accordingly, this may improve emitting efficiency of mercury gas and getting efficiency of the impurities inside of the light source body 100. Meanwhile, the getters 350 may have various shapes comprising an amalgam material for emitting mercury gas and a getter alloy for getting the impurities.

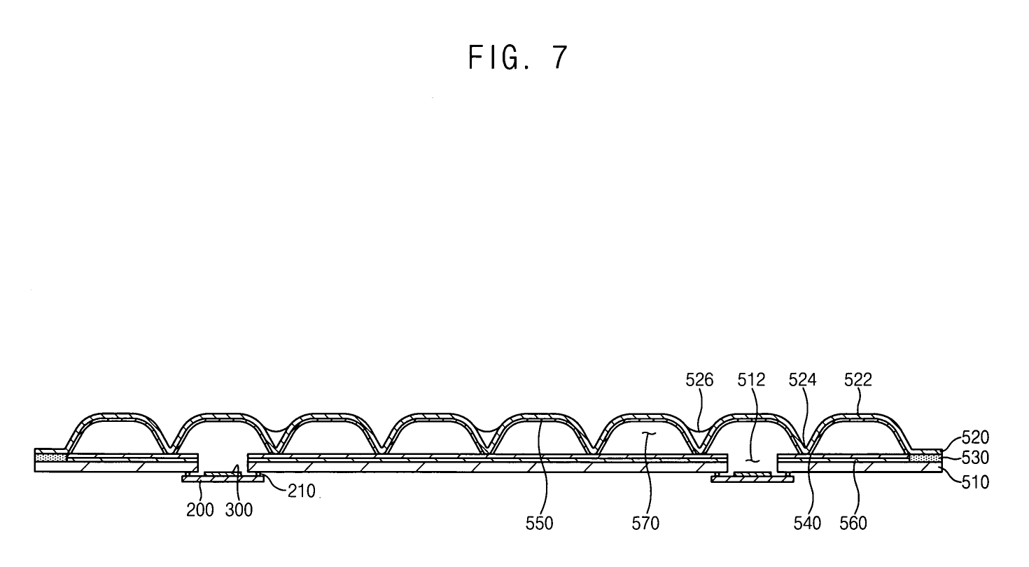

FIG. 6 is a perspective view of the light source body 500 of FIG. 1 according to another exemplary embodiment, and FIG. 7 is a cross-sectional view of the light source body 500 of FIG. 6. In this embodiment, the affixing members 200 and the getters 350 are the same as those shown in FIGS. 1 to 5 and their explanation will be omitted to avoid description duplication.

Referring to FIGS. 6 and 7, the light source body 500 comprises a first substrate 510, and a second substrate 520 coupled with the first substrate 510 and having multiple discharging regions 570.

The first substrate 510 has a flat rectangular shape, for example, and comprises a transparent glass substrate which transmits visible light and blocks ultraviolet light. Multiple opening portions 512 are formed on the first substrate 510 for air exhaust and injection of gases to be discharged. The second substrate 520 comprises the same transparent glass material as that of the first substrate 510. The second substrate 520 comprises multiple light emitting portions 522 and multiple partitioning portions 524. Each of the light emitting portions 522 is apart from the first substrate 510 for obtaining the discharging regions 570 and each of the partitioning portions 524 is formed between the adjacent discharging regions 570 and adjacent to the first substrate 510 for dividing the discharging regions 570. The second substrate 520 is formed by a forming method, for example.

In this embodiment, an end portion of the second substrate 520 is coupled with the first substrate 510 by a sealing member 530. The sealing member 530 comprises a glass material melted at a certain temperature. In other words, the first and second substrates 510 and 520 are sealed by the sealing member 530, which surrounds the edge portions of the first and second substrates 510 and 520. Because the sealing member 530 is disposed between the edge portions of the first and second substrates 510 and 520, each of the partitioning portions 524 is adhered to the first substrate 510 by a pressure difference between an inside and outside of the light source body 500. In other words, the discharging gases for plasma discharging are injected into the discharging regions 570. Gas pressure of the discharging gases is about 50 torr, and thus the pressure difference occurs between air pressure at about 760 torr and the gas pressure at about 50 torr. The partitioning portions 524 are adhered to the first substrate 510 by the pressure difference and the discharging regions 570 are formed.

Further, the partitioning portions 524 comprise multiple connecting paths 526. The connecting paths 526 are spaced apart from the first substrate 510 by a certain distance and connect the discharging regions 570 with each other. Each of the connecting paths 526 is formed at each of the partitioning portions 524 and alternates at a different edge of a pair of opposing edges defining each of the partitioning portions 524. The connecting paths 526 may be formed with the forming method of the second substrate 320. Accordingly, the gases injected through the opening portions 512 are carried to other discharging regions of the discharging regions 570 through the connecting paths 526, and finally the discharging gases are uniformly distributed in all of the discharging regions 570.

Meanwhile, the light source body 500 comprises first and second fluorescent layers 540 and 550, and a reflecting layer 560. The first and second fluorescent layers 540 and 550 are formed on the first and second substrates 510 and 520, respectively, and face each other. The first and second fluorescent layers 540 and 550 are excited by ultraviolet light occurring by plasma discharging and emit visible light. The reflecting layer 560 is disposed between the first substrate 510 and the first fluorescent layer 540. The reflecting layer 560 reflects the visible light to the second substrate 520, and thus prevents the visible light from being leaked to the first substrate 510.

A method of manufacturing the planar light source device will be now described.

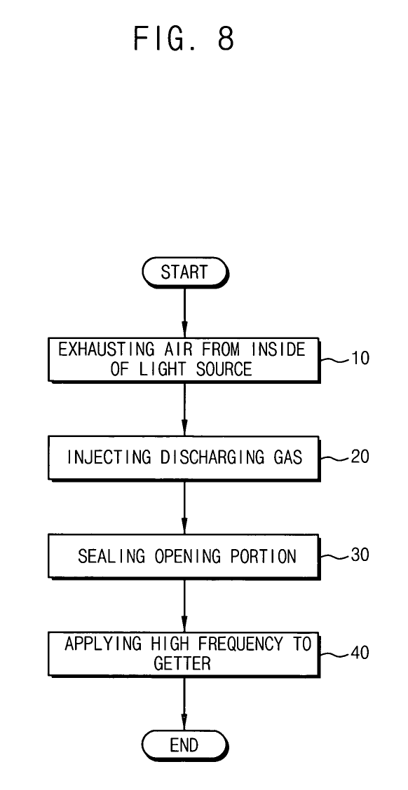

FIG. 8 is a flowchart of a method of manufacturing the planar light source device 1000 according to an exemplary embodiment.

Referring to FIG. 8, the method comprises exhausting air from the inside of the light source body 100, injecting the discharging gases into the inside of the light source body 100, sealing the opening portions 150, and applying a high frequency to the getters 300. In this exemplary embodiment, the high frequency is about 4 MHz to about 6 MHz. For example, the high frequency is about 5 MHz.

The exhausting step 10 exhausts air from the inside of the light source body 100 through the opening portions 150 using a vacuum pump. The injecting step 20 injects various types of discharging gases inside of the light source body 100 through the opening portions 150. The discharging gases comprise Krypton, Xenon, Ar, and Ne, etc, for example. The sealing step 30 seals the opening portions 150 using the affixing members 200. The adhesive member 200 is formed to surround the opening portions 150 or the affixing members 200, and is then adhered to the light source body 100 by heating and pressing the affixing members 200. The adhesive member 210 comprises a compound of a glass material, for example, which has a melting point less than a melting point of the light source body 100 and the affixing members 200. Accordingly, the adhesive member 210 is melted by about 350° C. and thus couples the affixing members 200 with the light source body 100.

Meanwhile, before the affixing members 200 are coupled with the light source body 100, each of the getters 300 is secured to each of the affixing members 200 by each of the securing members 310. Each of the getters 300 is on each of the affixing members 200. The securing members 310 may comprise a compound having a melting point less than a melting point of the affixing members 200 or double-sided tape, etc., for example. Accordingly, the affixing members 200 are coupled with the light source body 100 as the getters 300 are secured, and the getters 300 are located inside of the opening portions 150. The applying step 40 applies a high frequency to the getters 300 to emit mercury gas from the getter 300. The high frequency applied to the getters 300 is applied at about 5 Mhz for about 20 seconds, for example. By application of the high frequency, mercury gas is emitted from an amalgam material in the getters 300 and is supplied to the discharging regions 190 in the light source body 100. Meanwhile, the getters 300 continuously get the impurities in the discharging regions 190 as the getters 300 are secured to the affixing members 200.

Meanwhile, the method may further comprise forming the first and second electrodes 410 and 420. In the forming step, the first and second electrodes 410 and 420 are formed at both edges defining opposing outer edges of the light source body 100 and are formed at both edges of the discharging regions 190 in the longitudinal direction. Further, the first and second electrodes 410 and 420 intersect the discharging regions 190 and are formed by a spray coating method using a suitable conductive material, such as, a metal powder having Cu, Ni, Ag, Al, Cr, etc, for example. Further, the first and second electrodes 410 and 420 may be formed by an aluminum tape or an aluminum (Al) paste coating method. Further, the first and second electrodes 410 and 420 may be formed by a method of dipping both edges of the light source body 100 into a melted conductive material. The forming step may be performed before the exhausting step, after the sealing step, or after the applying step.

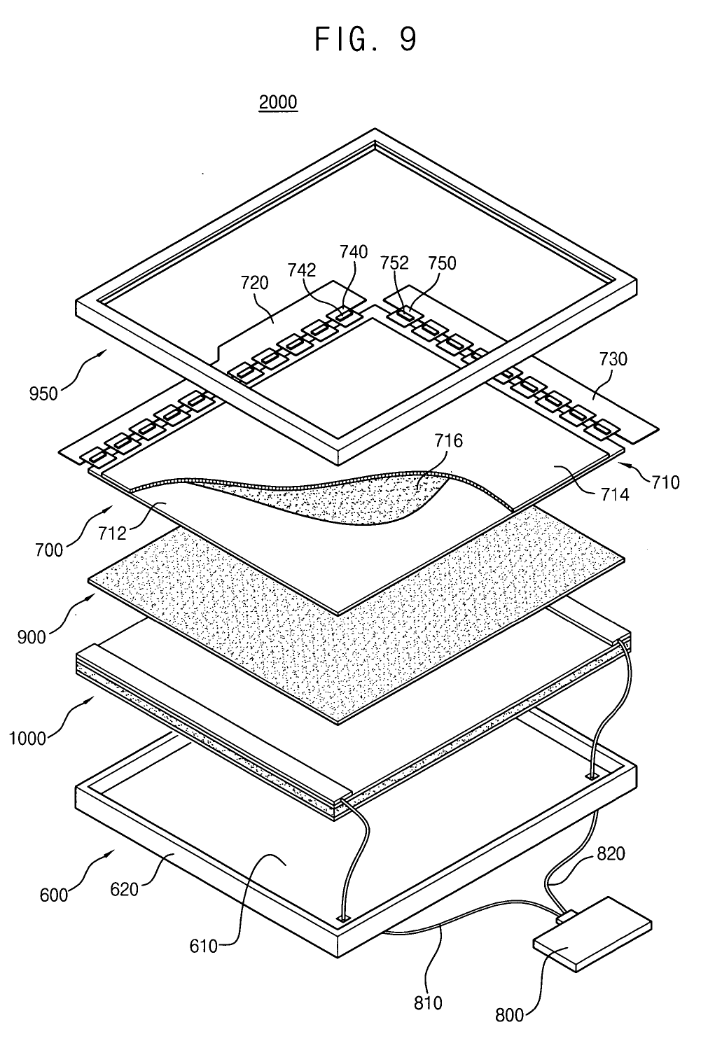

FIG. 9 is a perspective view of a liquid crystal display device 2000 according to an exemplary embodiment. In this embodiment, the planar light source device 1000 has the same configuration as those shown in FIGS. 1 to 7 and their explanation will be omitted to avoid the description duplication.

Referring to FIG. 9, the liquid crystal display device 2000 comprises the planar light source device 1000, a display unit 700, and an inverter 800. The display unit 700 comprises a liquid crystal panel 710, a data PCB 720 and a gate PCB 730. Driving signals from the data and gate PCB 720 and 730 are applied to the liquid crystal panel 710 via data and gate tape carrier packages (TCP) 740 and 750, respectively. Herein, each of the data and gate TCPs 740 and 750 comprises data and gate driving chips 742 and 752, respectively, for applying the driving signals from the data and gate TCPs 740 and 750 to the liquid crystal panel 710.

The liquid crystal panel 710 comprises a thin film transistor (TFT) substrate 712, a color filter substrate 714 facing the TFT substrate 712, and a liquid crystal 716 disposed between the two substrates 712 and 714. The TFT substrate 712 is a transparent glass substrate on which TFTs (not shown) are formed in a matrix. Source and gate terminals of each of the TFTs are connected to the data and gate lines, respectively, and a drain terminal of each of the TFTs is connected to a pixel electrode (not shown) having a transparent conductive material.

The color filter substrate 714 has red green blue (RGB) filters and a common electrode (not shown) having a transparent conductive material. The inverter 800 supplies discharging voltages to the first and second electrodes 410 and 420 of the planar light source device 1000 via first and second power lines 810 and 820. The inverter 800 generates first and second discharging voltages having opposite polarities relative to each other. In other words, the first and second discharging voltages have the same voltage level, but have opposite phases relative to each other.

Meanwhile, the liquid crystal display device 2000 comprises a receiving container 600, a diffusing member 900, and a top chassis 950. The receiving container 600 comprises a bottom portion 610 for receiving the planar light source device 1000 and multiple sidewalls 620 extending from the edges of the bottom portion 610 for obtaining a receiving space. The sidewalls 620 vertically extend from the edges of the bottom portion 610 and meet four sidewalls defining the planar light source device 1000. Accordingly, this results in preventing movement of the planar light source device 1000.

The diffusing member 900 diffuses light from the planar light source device 1000 and supplies uniform luminance of light to the liquid crystal panel 710. The diffusing member 900 comprises a diffusing plate having a flat shape and may comprise a diffusing plate having a sheet shape. Meanwhile, the liquid crystal display device 2000 may further comprise at least one prism sheet (not shown) disposed between the diffusing member 900 and the liquid crystal panel 710 for increasing front luminance of light toward the liquid crystal panel 710. The top chassis 950 is connected to the receiving container 600 while surrounding the edges of the liquid crystal panel 710 and secures the liquid crystal panel 710 to the top of the diffusing member 900. The top chassis 950 may prevent the liquid crystal panel 710 from being damaged by outside impact and prevent the liquid crystal panel 710 from being detached from the receiving container 600.

As described above, the present invention may reduce the thickness of the planar light source device by exhausting air from the inside of the light source body through the opening portions, injecting the discharging gases, and sealing the opening portions by a thin flat shape of the affixing members. Further, the present invention may form the wide surface area of the getters by affixing the affixing members to the light source body as the getters are secured to the affixing members. Further, the present invention may improve getting efficiency of the impurities and emitting efficiency of mercury gas by increasing the surface area of the getters.

Having described the embodiments of the present invention and its advantages, it should be noted that various changes, substitutions and alterations can be made herein without departing from the spirit and scope of the invention as defined by the appended claims.

1. A planar light source device, comprising:
a light source body that comprises multiple discharging regions and at least one opening portion for air exhausted injection of gases to be discharged;
at least one affixing member that is affixed to the light source body and seals the at least one opening portion;
at least one getter on the at least one affixing member and corresponds to the at least one opening portion; and
first and second electrodes that are formed on opposing edges defining the outer surface of the light source body.

2. The planar light source device of claim 1, further comprising an adhesive member being disposed between the light source body and the at least one affixing member, and having a lower melting point than the light source body.

3. The planar light source device of claim 1, wherein the at least one getter comprises an amalgam material and supplies mercury to the multiple discharging regions.

4. The planar light source device of claim 2, wherein the amalgam material is an alloy of mercury and natrium (Hg—Na).

5. The planar light source device of claim 1, wherein the at least one getter comprises a getter alloy and gets the impurities in the multiple discharging regions.

6. The planar light source device of claim 5, wherein the getter alloy is an alloy of zirconium and aluminum (Zr—Al).

7. The planar light source device of claim 1, further comprising at least one securing member being disposed between the at least one getter and the at least one affixing member.

8. The planar light source device of claim 7, wherein the securing member comprises at least one of frit and double-sided tape.

9. The planar light source device of claim 1, wherein the light source body comprises:
a first substrate;
a second substrate;
multiple partitioning members that are disposed between the first and second substrates and form the multiple discharging regions; and
a sealing member that adheres to the first and second substrates and seals the multiple discharging regions.

10. The planar light source device of claim 9, wherein the multiple partitioning members are formed parallel with each other and alternates being coupled with the sealing member at one end.

11. The planar light source device of claim 1, wherein the light source body comprises:
a first substrate;
a second substrate;
multiple light emitting portions that are formed on the second substrate and are apart from the first substrate;
multiple partitioning portions that are formed between the adjacent discharging regions and meet the first substrate; and
multiple connecting paths, each of the multiple connecting paths being formed at the end of every other one of the multiple partitioning portions.

12. The planar light source device of claim 11, wherein the light source body further comprises:
a reflecting layer that is formed on the first substrate;
a first fluorescent layer that is formed on the reflecting layer; and
a second fluorescent layer that is formed on the second substrate.

13. A display device, comprising:
a planar light source device comprising:
a light source body that has multiple discharging regions and multiple opening portions for air exhaust and injection of the discharging gases;
at least one affixing member that is affixed to the light source body and seals each of the multiple opening portions;
at least one getter that is secured to the at least one affixing member and corresponds to each of the multiple opening portions; and
first and second electrodes that are formed on opposing edges defining the outer surface of the light source body and intersect the multiple discharging regions;
a display unit that displays images using light from the planar light source device; and
an inverter that applies discharging voltages to the first and second electrodes for driving the planar light source device.

14. The display device of claim 13, wherein the light source body comprises:
a first substrate;
a second substrate;
multiple light emitting portions that are formed on the second substrate and are apart from the first substrate;
multiple partitioning portions that are formed between the adjacent discharging regions and meet the first substrate; and
multiple connecting paths, each of the multiple connecting paths being formed at the end of every other one of the multiple partitioning portions.

15. The display device of claim 13, wherein the at least one getter comprises an amalgam material and supplies mercury to the multiple discharging regions.

16. The display device of claim 15, wherein the amalgam material is an alloy of mercury and natrium (Hg—Na).

17. The display device of claim 13, wherein the at least one getter comprises a getter alloy and gets the impurities in the multiple discharging regions.

18. The display device of claim 17, wherein the getter alloy is an alloy of zirconium and aluminum (Zr—Al).

19. The display device of claim 13, further comprising:
a receiving container that receives the planar light source device;
a diffusing member that is disposed between the planar light source device and the display unit and diffuses light from the planar light source device; and
a top chassis that secures the display unit to the receiving container.

20. A method of manufacturing a planar light source device, comprising:
exhausting air in the inside of a light source body through at least one opening portion;
injecting gases to be discharged inside of the light source body through the at least one opening portion;
sealing the at least one opening portion using at least one affixing member, the at least one affixing member having a flat shape and being secured to at least one getter; and
applying a high frequency to the at least one getter for supplying mercury to the inside of the light source body.

21. The method of claim 20, wherein the sealing is to affix the at least one getter to one surface of the at least one affixing member and to correspond to the at least one opening portion.

22. The method of claim 20, wherein the sealing is to seal by heating after disposing an adhesive member between the light source body and the affixing member, the adhesive member having a lower melting point than the light source body.
